(19) United States
(12) Patent Application Publication
(10) Pub. No.: US 2003/0236865 A1
(43) Pub. Date: Dec. 25, 2003

(54) Method and system for configuring remote access to a server

(75) Inventors: Charles J. Anthe, Seattle, WA (US); Huseyin Gok, Sammamish, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/177,852

(22) Filed: Jun. 20, 2002

(51) Int. Cl. G06F 15/177

(52) U.S. Cl. 709/220

(57) ABSTRACT

A configuration wizard for configuring remote access for a server. The configuration wizard is utilized at the server to establish appropriate server settings by answering questions on a series of user interface screens provided by the wizard. The configuration wizard also creates a connection manager package. A user may configure a remote access connection with a client computer using the connection manager package. After the connection is configured, the user may access a link provided by the connection manager package to establish a connection with the server computer.

### TECHNICAL FIELD OF THE INVENTION

The present invention is generally directed computer systems, and more particularly is directed remote access between computers.

### BACKGROUND OF THE INVENTION

A virtual private network (VPN) is an on-demand connection between two computers in different locations. It includes the two computers, with one computer at each end of the connection, and a route, called a “tunnel,” over a public or private network, most often the Internet. To ensure privacy and secure communication, data transmitted between the two computers is typically encrypted by the Point-to-Point Tunneling Protocol (PPTP).

A VPN permits remotely located clients to access a server on a network. For example, a company having employees located dispersed throughout various locations may use virtual private networking to permit remotely-located employees to access data files or applications from a home location, with a much greater measure of security than provided by a simple connection.

Remote access for clients offers significant savings for small and mid-sized corporations. Duplication of server networks is not required, and secure data and communication exchanges may be made through existing connections.

There are two ways to establish a VPN connection: by dialing an Internet Service Provider (ISP) or by connecting directly to the Internet through an existing Internet connection, such as a user may have available when connected to a Local Area Network (LAN), a cable modem, or a Digital Subscriber Line (DSL) connection. In the first type, a connection is first made to the Internet Service Provider, and then the connection makes another call to the remote access server that establishes a Point-To-Point Tunnel Protocol (PPTP) tunnel to the remote access server. After authentication, the remote user can access the corporate network. In the latter types of connections, the PPTP driver makes a tunnel through the Internet and connects to the PPTP-enabled remote access server. After authentication, the user can access the corporate network, achieving the same functionality as in the preceding example.

In addition to VPN access, many companies enable dial-in access to a server or servers on a network. Dial-in access permits a direct telephone connection between the remotely located computer and a server, and usually requires a secure connection (e.g., via encryption) between the two. This service may work well, but is limited to modem transmission speeds, and may be subject to long distance charges.

While remote access connections work well for their intended purpose, one drawback to the connections is that setting up a Virtual Private Network or dial-in networking is difficult. At the server end, the terminology and instructions for setting up dial-in networking or VPN connections are confusing, and may be difficult for a small company to configure without professional help. If the server uses a firewall for security, the firewall must be set up correctly to allow data packets through the tunnel. The server's Internet Protocol (IP) address or Domain Name Service (DNS) name must be established, and then must be provided to each of the users.

Even after a server is successfully set up for remote access connections, each remote user that wishes to access the server must use a correctly configured computer to access the server, whether through a VPN connection or through dial-in. Typically, configuring the clients properly requires that an administrator go to each machine and configure the machine by hand. This method is costly, and may not always be available when clients have machines that are not readily available (e.g., home computers or laptop computers that are not taken to the main office). Often, to establish a connection for the unavailable computers, an administrator holds a long-distance telephone conference with the remote user, walking the user through the steps over the phone. This process is time consuming and expensive, and may be frustrating for an administrator and/or a computer user that desires remote access but knows little about computers.

### SUMMARY OF THE INVENTION

The present invention provides a configuration wizard for configuring remote access for a server. The configuration wizard is utilized at the server to establish appropriate server settings by answering questions on a series of user interface screens provided by the wizard.

In accordance with one aspect of the present invention, the configuration wizard requests the user to enable VPN access, dial-in access, or both. Selection of VPN access guides the user through a first set of user interfaces, and selection of dial-in access guides the user a second set of user interfaces. If both are selected, the user is guided through the user interfaces for VPN and dial-in.

If VPN is selected, then the configuration wizard may detect the availability of automatic selection of IP addresses by the server, such as Dynamic Host Configuration Protocol (DHCP). If available, DHCP or a similar protocol may be automatically selected by the configuration wizard in a process that is invisible to the user. Alternatively, one of the user interfaces in the wizard may prompt the user to select DHCP or to enter a range of IP addresses for client addressing.

If dial-in access is selected, the configuration wizard detects modems present on the server, and presents a user interface where the detected modems may be selected for dial-in access. The configuration wizard may be configured to show only modems that are not be used for other processes, such as facsimile. Alternatively, the user may be encouraged not to select a modem that may be used for other purposes.

If VPN access is selected, the user is prompted to enter the VPN server name. If dial-in access is selected, then the user is prompted to enter the phone number or numbers that remote clients may use to dial the server.

After the VPN and/or dial-in access information has been entered, the user commits the information, and the configuration wizard configures the server for remote access via dial-in networking and/or virtual private networking, depending upon the user's selections. If VPN access has been selected, then the configuration wizard may configure firewall software that is available on the server to permit VPN access. For example, the configuration wizard may instruct the firewall software to open ports (e.g., PPTP ports) for passing through of the VPN connection, create packet filters to allow selected network traffic through the firewall, and enable IP routing. Configuring the firewall process may be completely invisible to the user, and does not even require that the user have knowledge that firewall software is available on the server.

The configuration wizard also creates a connection manager package. The connection manager package is an executable that may be provided to client computers that, once run, enters the proper settings on the client computer for remote access to the server on which the connection manager package was formed, and installs a link or other tool to the remote access server. The user may simply access the link (e.g., by double-clicking on the link) to establish a connection with the remote access server. Authentication information, such as user name and password, may need to be entered.

The configuration wizard enters permanent information and/or settings into connection manager package. The permanent information or settings are determined based upon settings that are needed to establish the requested access (VPN and/or dial-in) on a client's computer. These settings and information may not be changed by a user at a client computer after the connection manager has been executed. The permanent information may include, for example, the server name. Examples of permanent settings include disabling of automatic proxy detection and/or requiring that a web proxy be used to connect to the Internet while a client is connected to the server.

The connection manager also includes default settings that are entered by the configuration wizard. The default settings configure the profile of the connection manager on the client machine. The default settings may be, for example, the phone numbers for the client to use to dial-in to the remote access server or the domain name for the network.

The connection manager package may be provided to a client machine in a variety of ways. As one example, for a remotely-located client (e.g., home computers), the connection manager package may be emailed, downloaded, or may be provided on a removable computer storage media such as a floppy disk. For clients that are connected to the network and that plan to later disconnect and remotely access the network (e.g., laptop computers), the connection manager package file may be automatically loaded to the computers as they are set up on the network. For example, the connection manager package may be included in a package that establishes the user's (non-remote) connection to the network. Alternatively, the connection manager package file may be provided in a shared folder on the network, and may be accessed and executed by a user prior to disconnecting from the network.

The remote access server configuration wizard of the present invention provides a simplistic method for configuring remote access for a server. Moreover, the connection manager package files provide a convenient method for client computers to configure VPN or dial-in access to the server.

Other advantages will become apparent from the following detailed description when taken in conjunction with the drawings, in which:

### BRIEF DESCRIPTION OF THE DRAWINGS

FIG. 1 is a block diagram representing a computer system into which the present invention may be incorporated;

FIG. 2 is a block diagram of an architecture of a computer system in which the present invention may be incorporated;

FIG. 3 is a representation of a graphical user interface that may be used with a remote access configuration wizard in accordance with one aspect of the present invention, the user interface showing a welcome screen;

FIG. 4 is a representation of a second graphical user interface that may be used with the remote access configuration wizard, the user interface permitting selection of a remote access method;

FIG. 5 is a representation of a third graphical user interface that may be used with the remote access configuration wizard, the user interface permitting selection of a client addressing method;

FIG. 6 is a representation of a fourth graphical user interface that may be used with the remote access configuration wizard, the user interface permitting entry of a VPN server name;

FIG. 7 is a representation of a fifth graphical user interface that may be used with the remote access configuration wizard, the user interface permitting selection of a modems for dial-in access;

FIG. 8 is a representation of a sixth graphical user interface that may be used with the remote access configuration wizard, the user interface permitting entry of dial-in phone numbers;

FIG. 9 is a flow diagram generally representing exemplary steps for detecting a protocol for automatic addressing of IP addresses in accordance with one aspect of the present invention;

FIG. 10 is a flow diagram generally representing steps for preparing a server for remote access in accordance with one aspect of the present invention;

FIG. 11 is a flow diagram generally representing steps for configuring remote access on the server in accordance with one aspect of the present invention;

FIG. 12 is a flow diagram generally representing steps for configuring a firewall on the server in accordance with one aspect of the present invention;

FIG. 13 is a flow diagram generally representing steps for forming a connection manager file in accordance with one aspect of the present invention;

FIG. 14 is a block diagram representing a structure for a connection manager package in accordance with one aspect of the present invention; and

FIG. 15 is a flow diagram generally representing steps for installing a connection manager file on a client computer in accordance with one aspect of the present invention.

### DETAILED DESCRIPTION

Exemplary Operating Environment

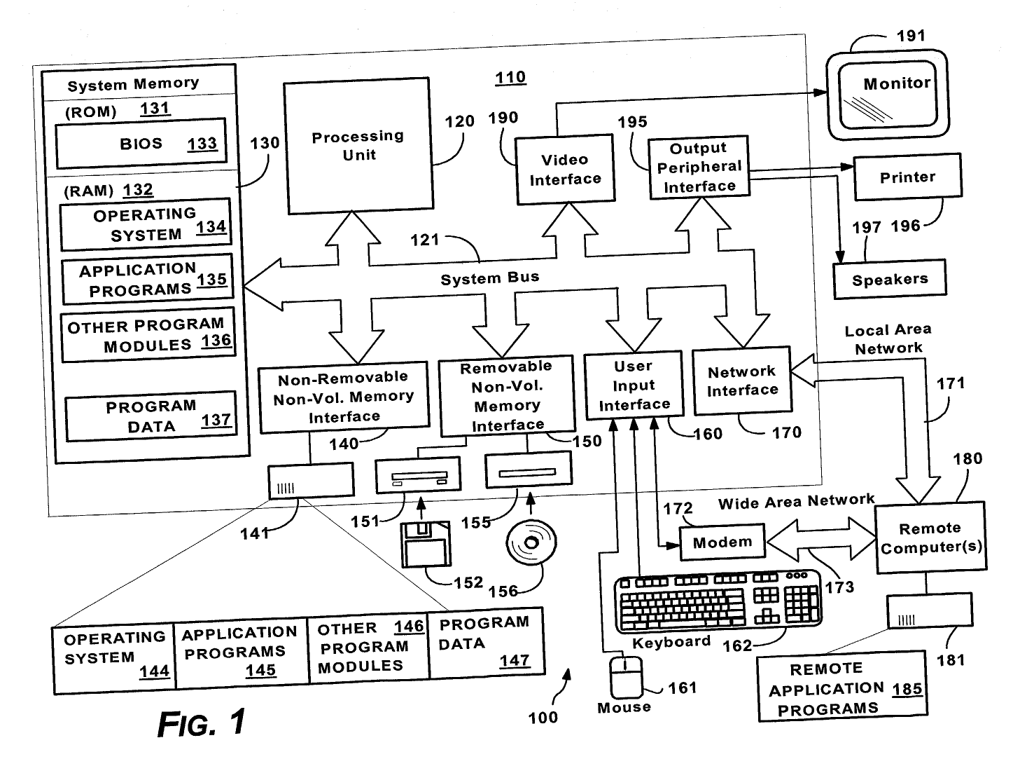

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, handheld or laptop devices, multiprocessor systems, microcontroller-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Configuring Remote Access to a Server

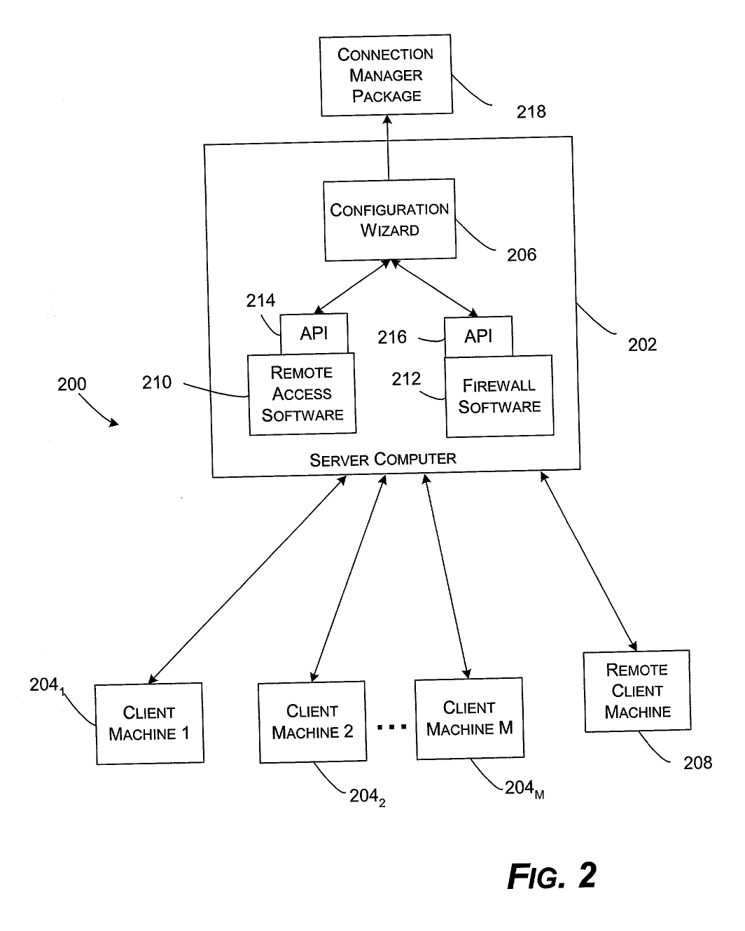

Turning now to the drawings, in which like reference numerals represent like parts throughout the several views, FIG. 2 shows an architecture for a computer system 200 embodying the present invention. The computer system includes a computer 200 (e.g., the computer 110) acting in this example as a server for one or more client computers 204₁, 204₂ . . . 204_{M} (e.g., the computer 180). The client computers 204 are typically connected to the server computer 202 through a direct connection, for example a LAN. However, as described further below, one or more of the client computers 204 may occasionally be disconnected from the direct connection with the server computer 202. In accordance with the present invention, a remote access server configuration wizard 206 is provided that configures the server computer 202 so that remote computers (e.g., the client computers 204 when they are disconnected) may remotely access the server computer 202.

The server computer 202 includes remote access software 210 associated therewith. The remote access software 210 may be, for example, Microsoft Corporation's Routing and Remote Access (RRAS) software. The server computer 202 also includes firewall software 212, such as Microsoft Corporation's Internet Security and Acceleration (ISA) Server firewall. The remote access software 210 and the firewall software 212 include one or more public Application Programming Interfaces (APIs) 214, 216, respectively.

For ease of description, in the described embodiment, the configuration wizard 206, the remote access software 210, and the firewall software 212 are described as being separate components, all residing on the server computer 202. However, the elements or components of the server computer 202 may be included entirely on the server computer 202, or may be distributed over a number of computers, or two or more of the elements on the server computer 202 may be combined to form a single component, or the functions of two or more of the components may be spread over multiple elements on the same machine or on multiple machines. As an example of one variation to the description given herein, the configuration wizard 206 may be a component of the remote access software 210.

In accordance with one aspect of the present invention, an operation of the configuration wizard 206 creates a connection manager package 218. As further described below, the connection manager package 218 is an executable that may be provided to client computers (e.g., one of the client computers 204) that, once executed, installs a link or other tool to access the server remotely. If one of the client computers 204 disconnects from the server computer 202 (e.g., a laptop that is taken on a trip), the user of the client computer 202 may simply access the link (e.g., by double-clicking on the link) to establish a remote access connection between the client computer and the remote access server. The connection manager package 218 is an executable file that is portable, and thus may be provided to a remote client computer 208 (e.g., via email or downloading), so that the remote client computer 208 may execute the package and establish a link to the server computer 202.

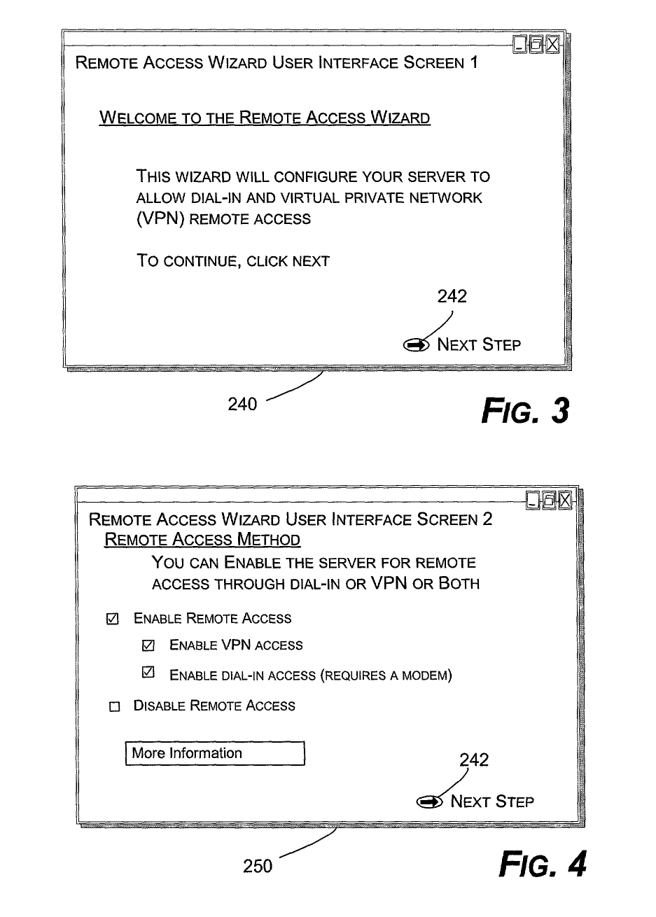

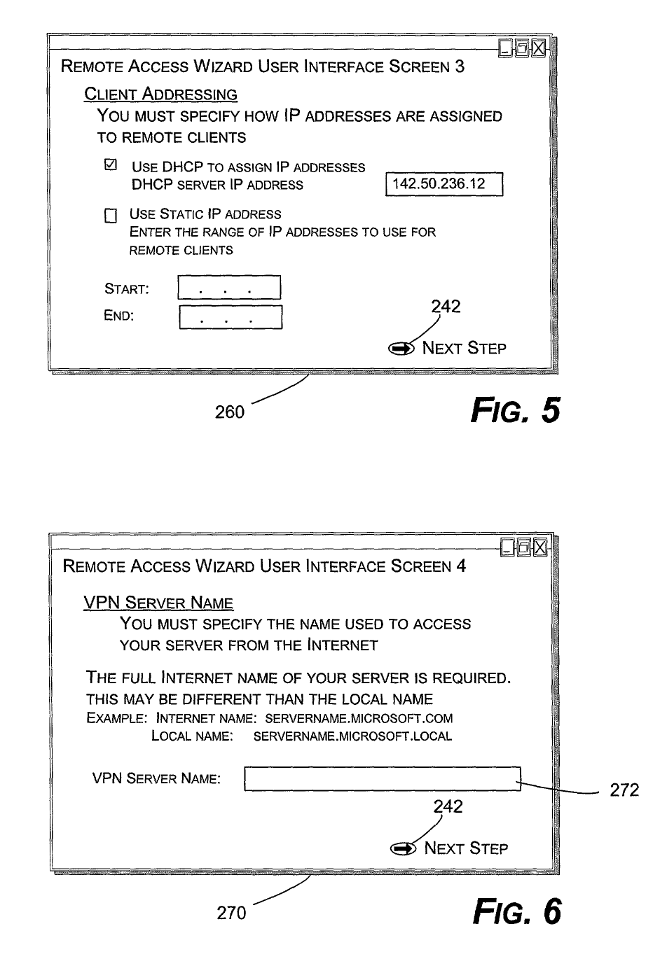

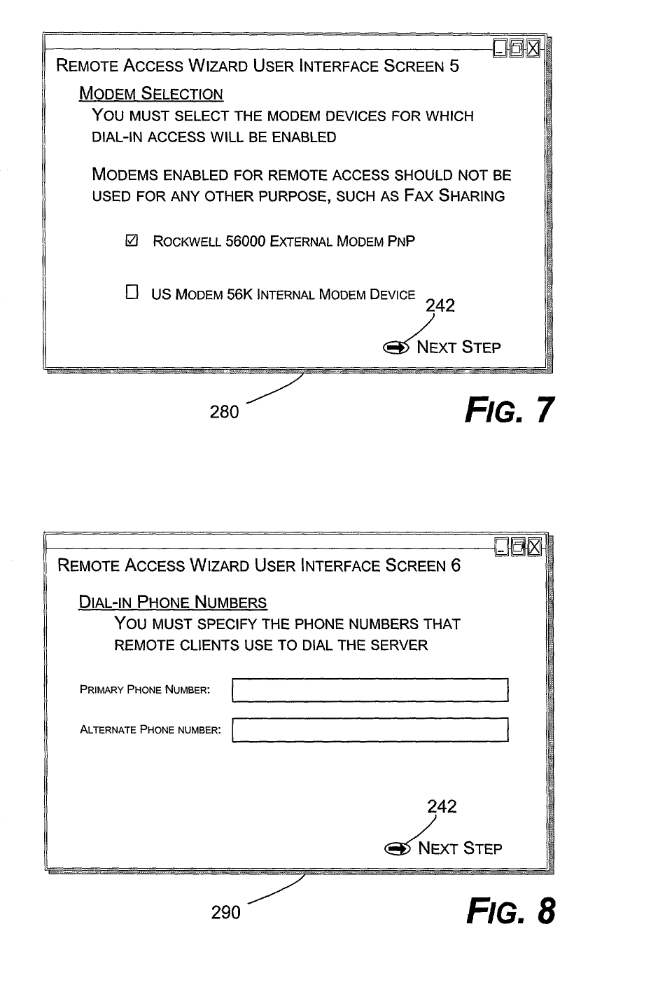

Several screens of user interfaces that may be used with the configuration wizard 206 in accordance with one aspect of the present invention are shown in FIGS. 3-8. Beginning at FIG. 3, a welcome screen 240 invites a user to set up remote access. The user may select a next button 242 to begin the wizard. At FIG. 4, a user seeking to configure remote access (e.g., on the server computer 202) is invited to select enabling of VPN access and/or enabling of dial-in access on a screen 250. If the user selects VPN access, the user is walked through the user interfaces in FIGS. 5 and 6, described below. If the user selects dial-in access, the user is walked through the user interfaces in FIGS. 7 and 8, also described below. If the user selects both, then the user is walked through the user interfaces in FIGS. 5-8.

The configuration wizard 206 may determine if any modem devices are enabled on the server, for example by accessing appropriate registry settings within an operating system for the server computer 202. If no modem devices are enabled on the server computer 202, then the option for dial-in access may be disabled.

Assuming the user has selected the enabling of VPN access, the user is directed to the user interface 260 in FIG. 5. On this screen, the user can select whether IP addresses will be addressed automatically (e.g., using the Dynamic Host Configuration Protocol (DHCP)) or may enter a range of IP addresses to use for remote clients.

If static IP addresses are chosen, then the screen will require a valid IP address range to be entered. For example, the configuration wizard 206 may check that the end IP address is larger than the start IP address. In addition, the configuration wizard 206 may warn if the IP range is greater than 100 addresses.

In accordance with one aspect of the present invention, the configuration wizard 206 may detect the availability of a protocol for automatic assigning of IP addresses (for the sake of convenience, hereinafter referred to generally as the availability of DHCP). As described below, if DHCP is not available on the server computer 202, then a check may be made to see if DHCP is available on another computer (e.g., another server) linked to the computer. If DHCP is available, in accordance with one aspect of the present invention, DHCP may automatically be selected by the configuration wizard 206, in which case the user interface 260 may be skipped by the configuration wizard altogether.

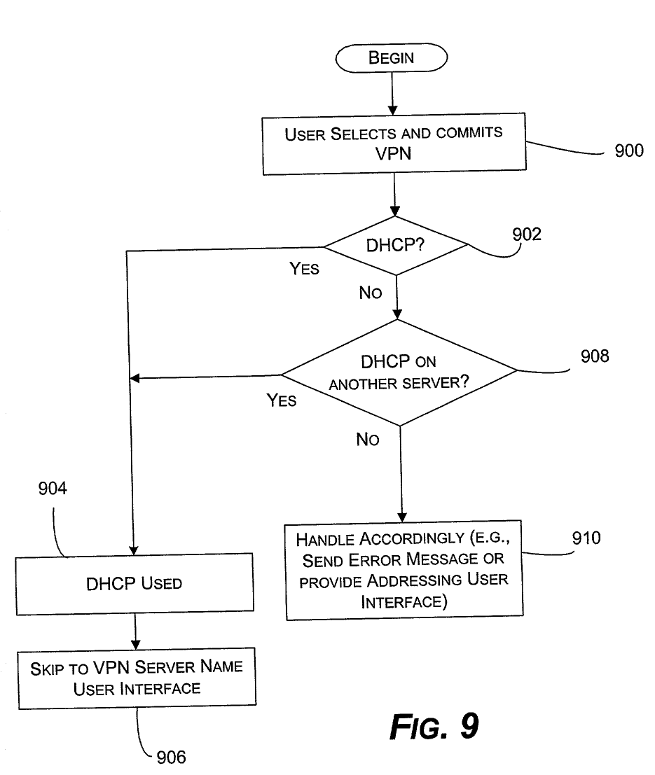

FIG. 9 shows one process that may be used in the detection of DHCP. Beginning at step 900, the user selects and commits VPN, for example by selecting VPN access using the user interface 250 in FIG. 4, and hitting the next button 242. At step 902, a determination is made whether or not DHCP is located on the server computer 202. If so, step 902 branches to step 904, where the DHCP on the server computer 202 is used.

If desired, the user interface 260 may be skipped by the configuration wizard 206 if DHCP is sensed as being available. DHCP would automatically be utilized if available on the network. In accordance with the embodiment, as a result of selecting VPN access on the user interface 250 (FIG. 4), and DHCP being sensed by the configuration wizard 206, the user is not presented the user interface 260 in FIG. 5, but instead is directed to the next user interface. For example, in the embodiment shown in the drawings, the user is directed to the user interface 270 (FIG. 6), where the user is asked to enter the VPN name for the server. Thus, a user would not be permitted to select a static IP address if DHCP were available.

If DHCP is not located on the server computer 202, then step 902 branches to step 908, where a determination is made whether DHCP is located on another server computer in the network. To do this, a DHCP relay agent may be used. DHCP relay agents are known, but a brief description is given here for the benefit of the reader. In summary, a DHCP relay agent is either a router or a host computer configured to listen for DHCP broadcast messages or requests and direct them to a specific DHCP server. Using relay agents eliminates the necessity of having a DHCP server on each physical network segment. Relay agents not only direct DHCP requests to remote DHCP servers, but also return remote DHCP server responses to the requester.

If the DHCP relay agent finds a DHCP server, then step 908 branches to step 904, where the DHCP server is utilized. Again, sensing that DHCP is available may result in the user interface 260 being skipped (step 906).

If the DHCP relay agent does not find a DHCP server, then step 906 branches to step 910, where the configuration wizard 206 may handle accordingly, such as by sending an error message, or directing the user to the user interface 260 and requiring that the user select static IP addresses.

After the method for client addressing has been designated via the user interface 260 (or as a result of the user interface 260 being skipped as described above), the user interface 270 may be shown to a user. On the user interface 270, the user is invited to enter the full name of the VPN server. A data entry field 272 is provided for this purpose. After the VPN server name is entered, the user clicks the next button 242 to advance to the next screen, which, if only VPN access was designated on the user interface 250 (FIG. 4), may be a commit screen (not shown). The commit screen may have, for example, a “finish” button, such as in known in the art.

If the user selected dial-in access via the user interface 250 (FIG. 4), then the user interface 280 (FIG. 7) is presented to the user. Please note that if only the dial-in access was selected on the user interface 250 (FIG. 4), then the user interface 280 may be the first screen seen by the user after the user interface 250 of FIG. 4. If, however, the user selected both VPN access and dial-in access on the user interface 250, the user may see the screens in FIGS. 5 and 6 before or after the user interface 280.

At the user interface 280, the configuration wizard 206 detects enabled modem devices on the server computer 202. The screen enumerates all modem devices that are detected on the server computer 202, and provides check boxes for each device. By selecting a device, the modem will be enabled for remote access when the user eventually commits to the wizard process. If the user does not select a device, then the ports for that device will be disabled for remote access. If desired, at least one device must be selected before the user will be allowed to continue.

Preferably, a modem is not selected that is designated for another service, such as receiving facsimiles. To prevent the selection of such a modem, the configuration wizard 206 may enumerate and show only those modems that are not designated for use with other services. To determine whether modems are designated for other services, the registry values for the modem may be checked, or the operating system may otherwise be accessed to determine if the modem is associated with another program, service, or application.

After the user has selected one or more modems, the user clicks “next” and the user interface 290 (FIG. 8) is presented. In this user interface 290, the user is requested to specify phone numbers that remote clients may use to dial the server computer 202. One or more phone numbers may be entered on the screen. After the phone numbers are entered, the user clicks “next” and is sent to a commit screen (e.g., a screen having a “finish” button).

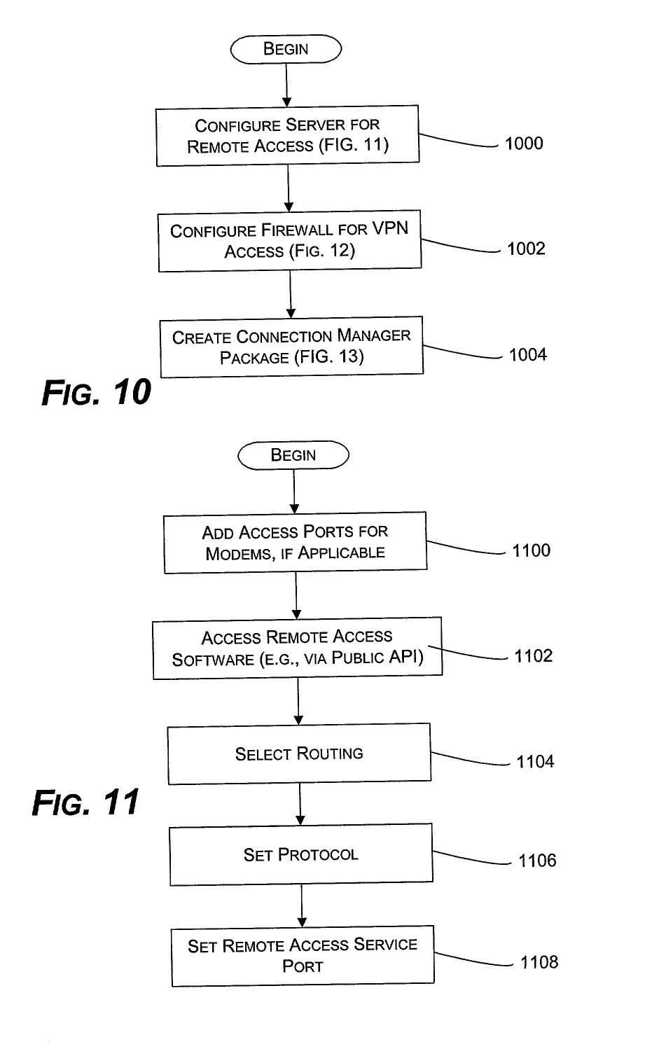

When the user commits to the settings and selections made through the user interfaces in FIGS. 3-8, the configuration wizard 206 begins the process of preparing the server computer 202 for remote access. General steps for this process are shown in FIG. 10. Beginning at step 1000, after the user has committed to the selections and settings through the user interfaces, the configuration wizard 206 configures the server computer 202 for remote access. This process is described further with reference to FIG. 11. At step 1002, the configuration wizard 206 configures the firewall for VPN access. It can be understood that this step only occurs if VPN access was selected on the user interface 250 in FIG. 4. The process of configuring the firewall for VPN access is described further with FIG. 12.

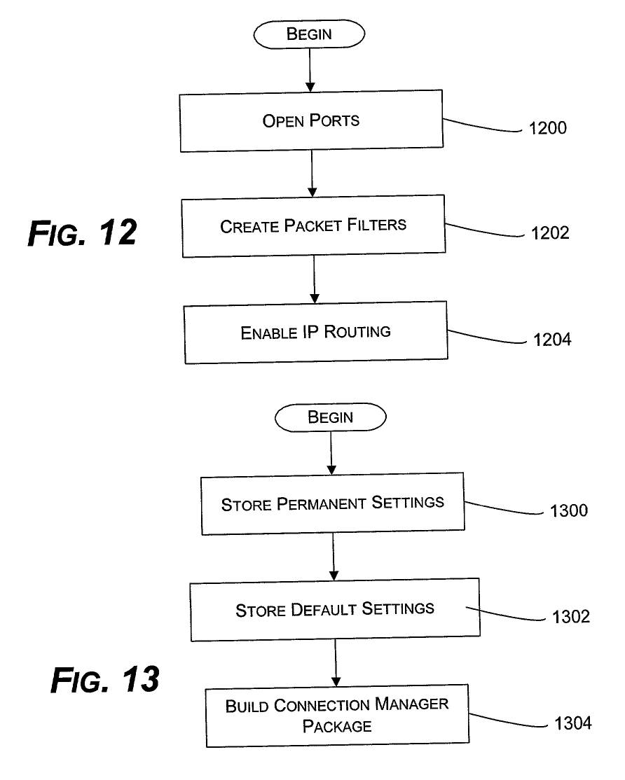

At step 1004, the configuration wizard 206 creates the connection manager package 218. This process is described further with FIG. 13.

The steps in FIG. 10 may be dependent upon the existence of certain components on the server computer 202. For example, the firewall may not be configured for remote access if the firewall software 212 is not located on the server computer 202.

FIG. 11 generally shows the steps for configuring remote access on the server computer 202 in accordance with one aspect of the present invention. Beginning at step 1100, access ports are added for the modems, if applicable. That is, if dial-in access was selected on the user interface 250 in FIG. 4, then access ports for the modems selected via the user interface 280 are added.

At step 1102, the remote access software 210 is accessed, for example via the public API 214. If selections between routing and remote access are available, then the remote access is selected at step 1104. Again, via the public API 214, the protocol for the remote access software 210 may be set (step 1106). This protocol may be, for example, PPTP, L2TP, or other encryption protocols.

At step 1108, the remote access service connection port is set, for example by configuring the remote access server to use the private network interface card (NIC) that is connected to the network, and not the public adaptor so that incoming clients are considered internal.

FIG. 12 shows steps for configuring a firewall with the configuration wizard 206 in accordance with an aspect of the present invention. Each of the instructions to the firewall may be made by the configuration wizard making calls s to conventional firewall software (e.g., the firewall software 212). The configuration wizard 206 may request these functions through publicly accessible APIs (e.g., the APIs 216). The public APIs for many firewalls are readily available. For example, the public APIs 216 are published for Microsoft Corporation's ISA server firewall at the Microsoft Developer's Network at http://msdn.microsoft.com.

In any event, beginning at step 1200, ports through the firewall for accessing the server computer 202 via VPN are opened. These ports may be, for example, PPTP ports.

At step 1202, the firewall is instructed by the configuration wizard 206 to create various packet filters to allow selected network traffic through the firewall. Internet Protocol (IP) packet filtering intercepts and evaluates packets before they are passed to higher levels in the protocols or to an application. This includes every IP packet, including Transmission Control Protocol (TCP) packets, User Datagram Protocol (UDP) datagrams, and other packet types.

At step 1204, the firewall is set to enable IP routing. IP routing allows IP packets from internal clients to be routed to external destinations, which is required for remote access clients.

In accordance with one aspect of the present invention, each of the steps in FIG. 12 occurs after a commit to the configuration wizard, and the process is invisible to a user that is using the connection wizard. A user may therefore set up a firewall for remote access connections without having knowledge of firewalls, or of the existence of a firewall on the server computer 202. This feature assures that firewall features are utilized despite the level of knowledge of the person implementing remote access on the server computer 202.

As stated above, the connection manager package 218 is an executable file that, when executed on a client computer 204 or 208, enters the proper settings for remote access and installs a link or other tool on a client computer 204 or 208 through which a user may establish a remote access connection between the client computer and the server computer 202. In general, to create the connection manager package 218, the connection wizard 208 must store the settings that are appropriate for accessing the server computer 202. The connection manager package 218 must also be configured so that, when executed, it properly installs the settings on the client computer 204.

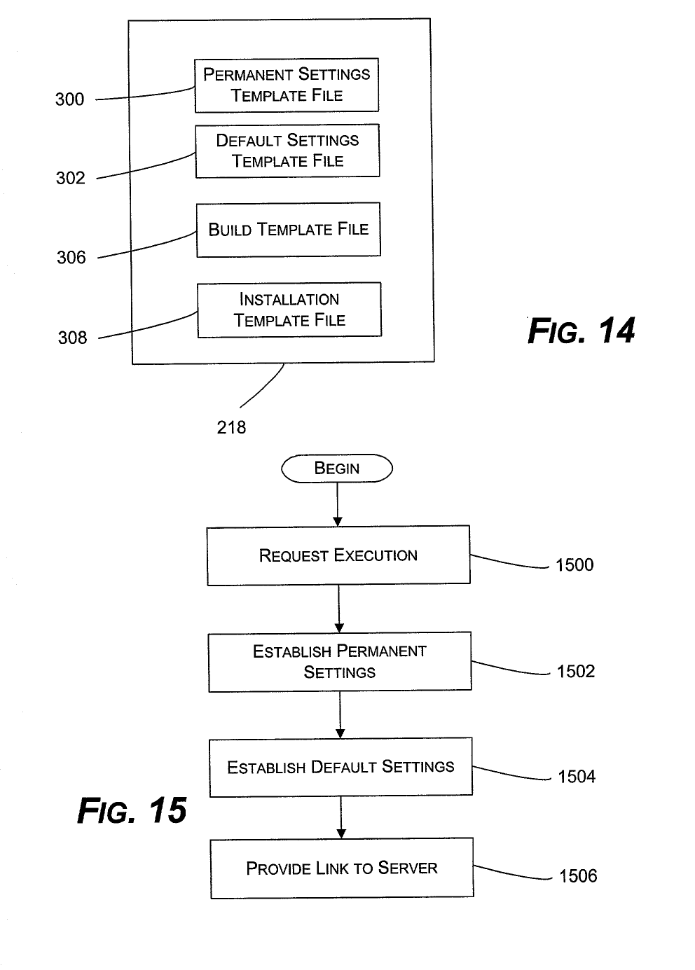

FIG. 13 shows general steps that may be used to create the connection manager package 218 in accordance with one aspect of the present invention. Beginning at step 1300, the configuration wizard 206 creates and stores permanent settings for the connection manager package 218. These are settings the user cannot change after the connection manager package 218 has been loaded on a client machine (e.g., the client machines 204 or 208). These settings may be stored, for example, in a permanent settings template file 300 (FIG. 14).

As one example of a permanent setting, the server computer 202 may require that a client computer 204 or 208 connected via remote access (either VPN or dial-in) use a web proxy service to connect to the Internet. In this example, the permanent settings template file would include instructions or a configuration file that is configured to disable automatic proxy, and to set the proxy setting to the name of the server (e.g., the server computer 202). In addition, some permanent settings may be based upon the connection type chosen by the user. For example, if VPN access is selected, then the tunnel address may be set to the VPN server name that was entered in the data entry field 272 on the user interface 270 (FIG. 6). Not all permanent settings are generated as a result of questions asked during by the configuration wizard 208 using the user interfaces 240-290. Some of the information may be accessed and provided via the server computer 202 (e.g., the server computer's name or the domain name). Other settings may be general to remote access, such as the number of times that a dial-in will be attempted, and the delay time between attempts (these may alternatively be default settings).

At step 1302, the configuration wizard 206 stores default settings for the connection manager package 218. These may be, for example, the phone numbers that were added in the user interface 290 (FIG. 8) for a dial-in connection. In addition, the domain name for the network may be entered here. Other settings may be made. The default settings may be stored in a default settings template file 302 (FIG. 14).

At step 1304, the connection manager package 218 is created. That is, an executable file is created that includes all of the information such as the permanent settings and the default settings. The connection manage package may be built in accordance with instructions in a build template file 306 (FIG. 14), for example.

Once built, the connection manager package 218 is ready for installation. The connection manager package 218 is a portable executable file that may be provided to clients such as the client computers 204 or the client computer 208. In the case of the client computers 204, the connection manager package 218 may be supplied to these computers while the computers are connected to the network. As an example, the connection manager package 218 may be resident on a shared folder on the server computer 202, and may be accessed by a client computer 204 when the user of the client computer 204 knows that the computer is to be used remotely. Alternatively, the server computer 202 may automatically deploy the connection manager package 218 on all, some, or select client computers 204 while they are connected to the network. For example, the server computer 202 may choose to deploy the connection manager package 218 on all laptops that are connected to the network. Deployment of the connection manager package 218 may be an isolated event, or may occur during a network setup procedure, for example.

The connection manager package 218 may also be provided to remote client computers (e.g., the client computer 208), for example by email or as a downloadable file. Alternatively, the connection manager package 218 may be supplied on removable computer-readable medium, such as a computer disk.

When present on a client computer (e.g., the client computers 204 or client computer 208), the connection manager package 218 may be accessed by a user, such as by initiating a set up procedure, or otherwise running the executable for the connection manager package 218. Doing so causes the connection manager package 218 to be installed on the user's computer. How the connection manager is installed on a client computer may be stored in an installation template file 308 (FIG. 14) in the connection manager package 218.

In general, during execution of the connection manager package 218 on a client computer 204 or 208, the connection manager package enters the permanent and default settings in the template files 300 and 302 in the client computer's registry. Basically, the connection manager package 218 performs, via public APIs that are available on the client computer 202, the functions a user would perform in manually configuring remote access on the client computer. The software is already available on the user's computer; the connection manager package 218 accesses that software and does the work for the user.

FIG. 15 is a flow diagram generally representing steps for installing a connection manager file on a client computer in accordance with one aspect of the present invention. Beginning at step 1500, a user requests execution of the connection manager package 218 on a client computer 204 or 208. At step 1502, the permanent settings are established on the client computer 204. Then, at step 1504, the default settings are established on the client's computer. Finally, a link for setting up client access is provided on the computer, for example on the desktop, at step 1506.

The present invention provides a clearly understandable method of setting up remote access on a server computer (e.g., the server computer 202). In addition, a user may configure a remote access connection with a client computer 204 using the connection manager package 218. After the connection is configured, the user may access a link provided by the connection manager package 218 to establish a connection with the server computer 202.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A computer-readable medium having computer-executable instructions comprising:
configuring a first computer for remote access;
responsive to configuring the first computer for remote access, creating a connection manager package, the connection manager package comprising an executable file that, when executed on a client computer, configures the client computer for a remote access connection to the first computer.

2. The computer-readable medium of claim 1, wherein configuring the first computer for remote access comprises:
providing a wizard configured to receive remote access preferences; and
responsive to committing preferences to the wizard, configuring the first computer for remote access.

3. The computer-readable medium of claim 2, wherein the executable file is further configured such that, when executed on a client computer, a tool is provided for establishing a connection between the first computer and the client computer.

4. The computer-readable medium of claim 3, wherein the tool is a link.

5. The computer-readable medium of claim 1, wherein the remote access connection comprises a virtual private networking connection.

6. The computer-readable medium of claim 5, wherein the remote access connection comprises a dial-in connection.

7. The computer-readable medium of claim 1, wherein the computer package comprises permanent settings that may not be altered at a client computer after a remote access connection has been configured by the executable file.

8. The computer-readable medium of claim 1, wherein the computer package comprises default settings that may be altered at a client computer after a remote access connection has been configured by the executable file.

9. A computer-readable medium having computer-executable instructions comprising:
accessing information about a first computer, the information including settings for accessing the first computer through remote access; and
creating a connection manager package, the connection manager package including the information and comprising an executable file that, when executed on a client computer, configures the client computer for a remote access connection to the first computer.

10. The computer-readable medium of claim 9, wherein the information includes settings for accessing the first computer through a virtual private networking connection.

11. The computer-readable medium of claim 10, wherein the remote access connection comprises a virtual private networking connection.

12. The computer-readable medium of claim 10, wherein the information includes settings for accessing the first computer through a dial-in connection.

13. The computer-readable medium of claim 12, wherein the remote access connection comprises a dial-in connection.

14. The computer-readable medium of claim 9, wherein the computer package comprises permanent settings that may not be altered at a client computer after a remote access connection has been configured by the executable file.

15. The computer-readable medium of claim 9, wherein the computer package comprises default settings that may be altered at a client computer after a remote access connection has been configured by the executable file.

16. In a computer system having a user interface selection device, a method comprising:
providing a user interface for selection therefrom, the user interface comprising selections for configuring a first computer for remote access, the user interface including an option to select configuration of the first computer for remote access by a virtual private networking connection and an option to select configuration of the first computer for remote access by dial-in;
responsive to selecting configuration of the first computer for remote access by a virtual private networking connection, providing selections for configuring a first computer for remote access via a virtual private networking connection;
responsive to selecting configuration of the first computer for remote access by dial-in, providing selections for configuring a first computer for dial-in remote access; and
responsive to selecting configuration of the first computer for remote access by a virtual private networking connection and selecting configuration of the first computer for remote access by dial-in, providing selections for configuring a first computer for remote access via a virtual private networking connection and for dial-in access.

17. In a computer system having a user interface selection device, a method comprising:
providing a user interface for selection therefrom, the user interface comprising selections for configuring a first computer for remote access, the user interface including an option to select configuration of the first computer for remote access by dial-in;
responsive to selecting configuration of the first computer for remote access by dial-in, accessing the first computer to determine available modems for dial-in; and
displaying available modems for selection.

18. The method of claim 17, further comprising:
responsive to selecting available modems, configuring the first computer for remote access through the selected available modems.

19. The method of claim 17, wherein accessing the first computer to determine available modems for dial-in comprises determining whether modems are being used by other services, and, selecting as available modems the modems that are not be used by other services.

20. In a computer system having a user interface selection device, a method comprising:
providing a user interface for selection therefrom, the user interface comprising selections for configuring a first computer for remote access, the user interface including an option to select configuration of the first computer for remote access by a virtual private networking connection;
responsive to selecting configuration of the first computer for remote access by a virtual private networking connection, accessing the first computer to determine whether automatic selection of Internet Protocol addresses is available; and
responsive to automatic selection of Internet Protocol addresses being available, configuring the first computer for automatic selection of Internet Protocol addresses.

21. The method of claim 19, wherein automatic selection of Internet Protocol addresses comprises use of Dynamic Host Configuration Protocol.

22. The method of claim 19, further comprising, responsive to automatic selection of Internet Protocol addresses not being available, providing a user interface for designating a list of Internet Protocol addresses.
